(19) United States
(12) Patent Application Publication
(10) Pub. No.: US 2004/0213137 A1
(43) Pub. Date: Oct. 28, 2004

(54) Shock absorber

(75) Inventors: Chiu-An Huang, Yuan Lin Hsien (TW); Chiao-Fan Huang, Hsin Chuang City (TW)

Correspondence Address: Ladas & Parry, 26 West 61st Street, New York, NY, 10023, US

(73) Assignee: BENQ CORPORATION

(21) Appl. No.: 10/823,338

(22) Filed: Apr. 13, 2004

(30) Foreign Application Priority Data
Apr. 23, 2003 (TW) 92109514

(51) Int. Cl. G11B 7/00

(52) U.S. Cl. 369/139; 369/44.32; 369/53.18

(57) ABSTRACT

A shock absorber used for absorbing shock energy generated by a vibrator positioned on a connecting plate is disclosed. The shock absorber has a column, a support plate and a cover plate. The column has an upper damper, a neck zone, a lower damper and a through hole. The neck zone is connected to the connecting plate. The cover plate is positioned above and covered the upper damper and the support plate is located below the lower damper for holding the column. A cylinder is connected to the support plate via the through hole so as to secure the column and the vibrator with the support plate. Furthermore, the neck zone has at least one groove to reduce a contacting area between the neck zone and the connecting plate so as to reduce a horizontal vibration frequency of the column in a horizontal direction.

### FIELD OF THE INVENTION

The present invention relates to a suspension type shock absorbing system for a disc drive, and particularly to a shock absorber for a suspension type shock absorbing system.

### BACKGROUND OF THE INVENTION

A compact disc is a digital optical recording medium for storing a large amount of data through pits and lands formed on a recording layer. A disc drive has a pickup head to read laser reflection of the recording layer and transform reflection signals to digital data to accomplish the data reading process. While the disc drive is reading data, the compact disc is rotated at high speed. In order to prevent the high speedy rotation from generating vibration and affecting reading quality, the disc drive usually has shock absorbers located inside to minimize vibrations.

Refer to FIG. 1 for a conventional double suspension shock absorbing system in a disc drive. The disc drive mainly includes a base 10 of the disc drive, a tray 11 to load the compact disc 12 thereon, a rotary device 17 to hold and drive the compact disc 12 to rotate at high speed, a pickup head 18 to read digital data stored on the recording layer of the compact disc 12, and a suspension type shock absorbing system 15. The rotary device 17 is fixed on the base 10 of the disc drive by the suspension type shock absorbing system 15 which absorbs the shock energy generated by the rotary device 17.

Refer to FIG. 2 for a conventional double suspension shock absorbing system. The base 10 of the disc drive is a rectangular frame (referring to FIG. 1). The rotary device 17 is fixed on the base 10 by the double suspension shock absorbing system 15. The double suspension shock absorbing system 15 includes a primary suspension plate 20, a secondary suspension plate 22 and a plurality of shock absorbing dampers 24 and 26. The rotary device 17 is mounted onto the primary suspension plate 20. The primary suspension plate 20 is coupled to the base 10 by the shock absorbing dampers 24; the secondary suspension plate 22 is located above the primary suspension plate 20, and is coupled to the primary suspension plate 20 by the shock absorbing dampers 26; therefore; the double suspension shock absorbing system 15 is completed. The double suspension shock absorbing system 15 mainly aims at absorbing the shock energy generated by the rotary device 17.

Referring to FIG. 3A, the base 10 is coupled to the main suspension plate 20 by using the shock absorbing damper 24 in the conventional technique. The shock absorbing damper 24 is a column including an upper damper 241, a lower damper 242, a neck zone 243 and a through hole 244 in the center of the column. The primary suspension plate 20 is coupled on the neck zone 243 and sandwiched between the upper damper 241 and the lower damper 242. The lower damper 242 is mounted on the base 10. The upper damper 241 is covered with a cover plate 245. A cylinder 246 positioned in the through hole 244 to secure the shock absorbing damper 24 and the primary suspension plate 20 to the base 10 of the disc drive.

Referring to FIG. 3B, the main suspension plate 20 is coupled to the secondary suspension plate 22 by using the shock absorbing damper 26 in the conventional technique. The structure of the shock absorbing damper 26 is similar to that of the shock absorbing damper 24 as shown in FIG. 3A. The shock absorbing damper 26 has a neck zone 263 to couple with the secondary suspension plate 22. A lower damper 262 is mounted onto the primary suspension plate 20. A cylinder 266 positioned in the through hole 264 to secure the shock absorbing damper 26 and the secondary suspension plate 22 to the primary suspension plate 20.

FIG. 4 shows the relationship of various damping factors to amplifying factors and the frequency of a mechanical system under damper vibrations. The kinetic equation of the mechanical system under damper vibrations is:

Mx″+Cx′+Kx=P sin (ωₙt)

where M is the weight of the system, C is the damper value of the system, K is the equivalent elasticity coefficient of the system, and P is an external force applying on the system. In addition, ωₙ is the operation frequency generated by the external force, C/Cc is the damping factor, Cc is the critical damping value and equals to 2×(M×ω), ω/ωₙ is the frequency ratio, ω is a natural vibration frequency of the system and equals to (K/M)^{1/2}, x/δ is the amplifying factor, δ is the system static deformation caused by the external force P and equals to P/K, and x is system vibration amplitude under the vibration of the damper.

When the external force of a mechanical system is P, the damping factor is zero, the frequency ratio is one, a resonance will occur because the damper value of the system is zero and the operation frequency ωₙ of the system is the same as the natural vibration frequency ω. Therefore, the operation frequency of the external force P is called the resonance frequency. The amplitude of the system becomes very large because of the resonance. On the other hand, when the damping factor is one and the frequency ratio is one, a resonance occurs because the damping value of the system equals to the critical damping value Cc, and the operation frequency of the system is the same as the natural vibration frequency ω. Even the resonance occur, the amplitude of the system will not increase too much; it means a great portion of resonant energy is absorbed by the damper, and less vibration and interference will be subjected to the system. In addition, product lifetime and operation quality of the mechanical system may be improved.

Based on previous discussion, when the system is a disc drive, and in order to minimize the vibration when the disc drive is operating, the shock absorbing damping C should be equal to the critical damping value Cc, and the natural vibration frequency should be designed proximate to the operation frequency of the disc drive. Such a design enables the shock absorbing damper to absorb maximum shock when resonance occurs.

Referring to FIG. 3A, in a conventional shock absorbing damper 24, the upper and lower dampers 241 and 242 have respectively a notch (such as a chamfer) 247 on the outer side. The bending location of the notch 247 and the side surface of the neck zone 243 are usually located on the same vertical line. As a result, the upper damper and the lower dampers 241 and 242 are too soft in the vertical direction. As a result, the natural vibration frequency of the shock absorber 24 in the vertical direction is much lower than the operation frequency of the rotary device 17. On the other hand, as the contacting area between the neck zone 243 and the primary suspension plate 20 is very large, the rigidity in the horizontal direction of the neck zone 253 is excessively high. This causes the natural frequency of the shock absorbing damper 24 in the horizontal direction much greater than the operation frequency of the rotary device 17. Due to the structural limits of the conventional shock absorbing damper, the natural vibration frequency of various directions cannot coincide with the operation frequency of the rotary device, the shock absorbing effect of the disc drive is poor and reading quality is also affected.

Therefore, how to improve the double suspension shock absorbing system without altering the dimensions and specifications of the inner elements of the disc drive becomes an important issue pending to be resolved in the industry.

### SUMMARY OF THE INVENTION

Therefore the primary object of the invention is to provide a shock absorber with natural vibration frequencies close to the operation frequency.

The shock absorber according to the invention aims at absorbing shock energy generated by a vibrator. The vibrator is located on a connecting plate. The shock absorber includes a column, a support plate and a cover plate. The column includes an upper damper, a neck zone, a lower damper and a through hole. The connecting plate is coupled too the neck zone and located between the upper damper and the lower damper. The support plate is located below the lower damper to hold the column. The cover plate covers the upper damper from above. A cylinder connects to the support plate via the through hole so as to secure the column and the vibrator with the support plate.

In one aspect of the invention, the neck zone has at least one groove to reduce the contacting area between the neck zone and the connecting plate, increase the flexibility of the column in the horizontal direction, and reduce the horizontal natural vibration frequency of the column in the horizontal direction to coincide with the operation frequency of the vibrator. The upper damper has a first recess, a first apex is formed on a first inmost position of the first recess, a second apex is formed on a second inmost position of the groove, and the second apex is staggered vertically from the first apex for adjusting the vertical vibration frequency of the column in the vertical direction. The lower damper has a second recess, a second apex is formed on a second inmost position of the groove, a third apex is formed on a third inmost position of the second recess, and the second apex is staggered vertically from the third apex for adjusting the vertical vibration frequency of the column in the vertical direction.

In another aspect of the invention, the support plate is a base of a disc drive, and the vibrator is a rotary device of the disc drive. The connecting plate is a primary suspension plate. The rotary device is fixed to the primary suspension plate. The shock absorbing damper absorbs the shock energy generated by the rotary device during rotation so that the disc drive can operate steadily and achieve an improved operation quality.

In yet another aspect, the connecting plate according to the invention may be the secondary suspension plate. The support plate may be the primary suspension plate. The rotary device is fixed to the primary suspension plate. As previously discussed, the shock absorber according to the invention is adopted for use on the shock absorbing system of a disc drive.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional disc drive.

FIG. 2 is a schematic view of a conventional double suspension shock absorbing system.

FIGS. 3A and 3B are schematic views of a conventional double suspension shock absorbing system with dampers to absorb vibration of the rotary device.

FIG. 4 is a chart showing the relationship of various damping factors and amplifying factors and the frequency of a mechanical system under damper vibration.

FIG. 5 is a schematic view of a first embodiment of the shock absorber of the invention.

FIG. 6 is a schematic view of a second embodiment of the shock absorber of the invention.

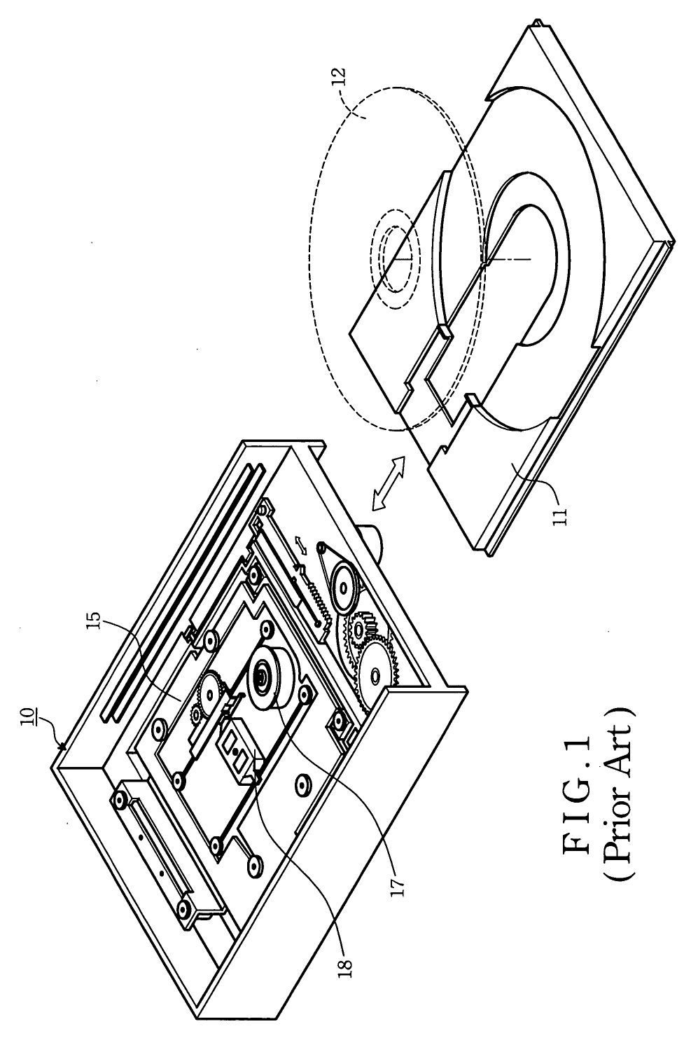

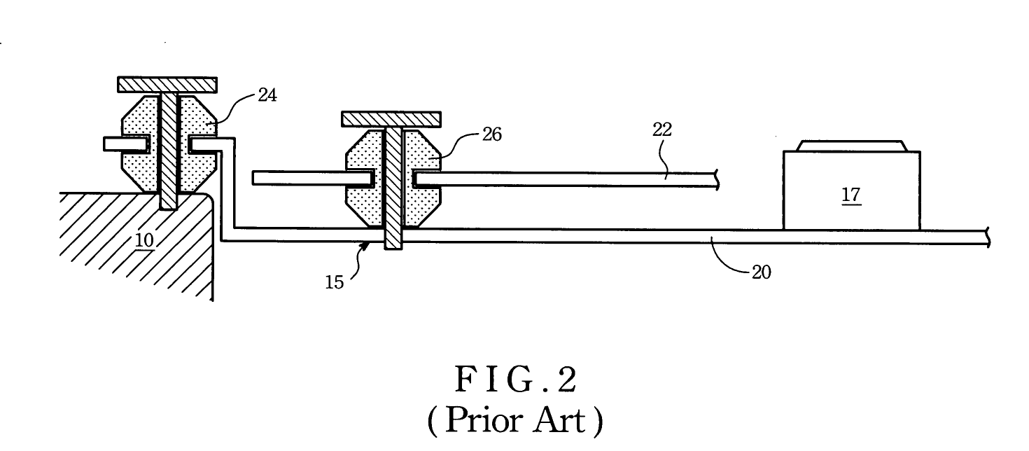

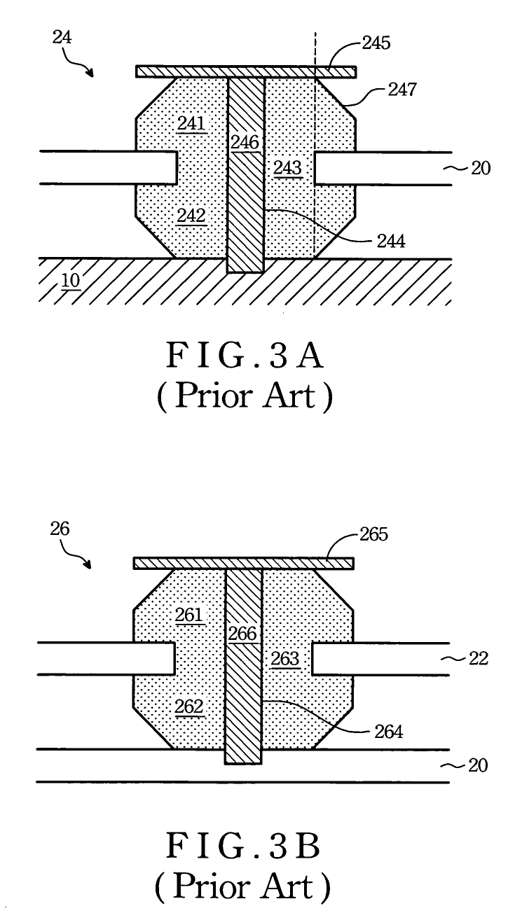

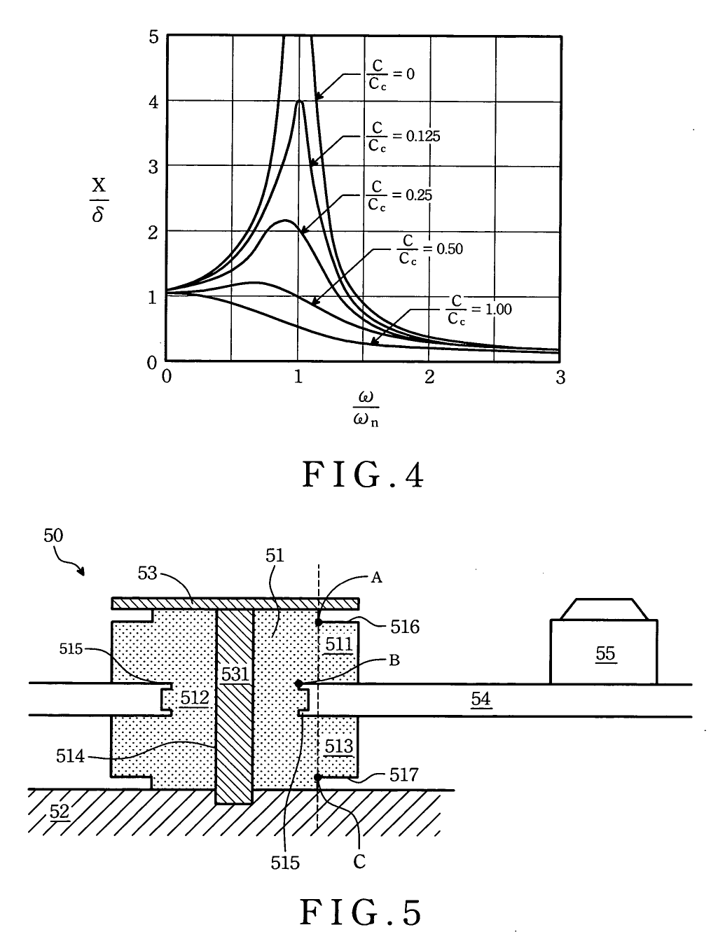

### DESCRIPTION OF THE PREFERRED EMBODIMENTS

The invention is to provide a shock absorber to absorb shock energy generated by a vibrator. The embodiments discussed below are shock absorbers used in disc drives. Each disc drive has a rotary device as a vibrator during operation. The shock absorber mainly is used to absorb shock energy generated by the vibrator.

Referring to FIG. 5, a first embodiment of the shock absorber 50 according to the invention is disclosed. The shock absorber 50 includes a column 51, a support plate 52 and a cover plate 53. The column 51 may be made from a shock absorbing material such as synthetic rubber or the like. The column 51 includes an upper damper 511, a neck zone 512, a lower damper 513 and a through hole 514. The shock absorber 50 is to absorb shock energy generated by a vibrator 55. In this embodiment the vibrator 55 is a rotary device 55 of the disc drive.

The neck zone 512 is located between the upper damper 511 and the lower damper 513, is formed in a structure like a neck because the diameter of this zone 512 is smaller than that of the upper and lower dampers 511 and 513. The column 51 is coupled with a connecting plate 54 on the neck zone 512. The lower damper 513 supports the column 51 on the support plate 52. In this embodiment, the connecting plate 54 is the primary suspension plate of a double suspension shock absorbing system, and the support plate 52 is the base of the disc drive for holding the double suspension shock absorbing system. The vibrator 55 (such as the rotary device) is secured to the primary suspension plate (i.e. the connecting plate 54). The cover plate 53 covers the upper damper 511 from above. A cylinder 531 connected to the supporting plate via the through hole 514 so as to connect the column 51 and the connecting plate 54 to the support plate 52.

The neck zone 512 of the column 51 has at least one groove 515. The groove 515 can reduce the contacting area between the neck zone 512 and the connecting plate 54 to increase the flexibility of the column 51 in the horizontal direction without reducing the height of the neck zone 512. Therefore, the horizontal natural vibration frequency of the column 51 in the horizontal direction is reduced to be proximate the operation frequency of the vibrator 55 and to improve the shock absorbing effect in the horizontal direction.

The upper damper 511 has a first recess 516, and the lower damper 512 has a second recess 517. A first apex A is defined in the inmost portion of the first recess 516, and a second apex B is defined in the inmost portion of the groove 515. The first apex A and the second apex B are staggered vertically to adjust the vertical natural vibration frequency of the column 51 in the vertical direction. In addition, a third apex C is defined in the inmost portion of the second recess 517, and the third apex C is staggered from the second apex B vertically to adjust the vertical natural vibration frequency of the column 51 in the vertical direction. Therefore, the vertical natural vibration frequency coincides with the operation frequency of the vibrator 55 to generate better shock absorbing effect in the vertical direction.

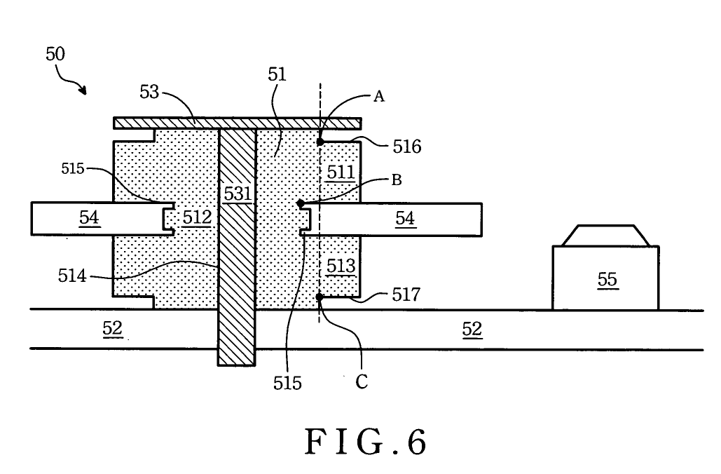

Referring to FIG. 6, a second embodiment of the shock absorber of the invention is disclosed. The structure of this embodiment is substantially similar to that of the first embodiment set forth above. In this embodiment, the connecting plate 54 is the secondary suspension plate of the double suspension shock absorbing system, while the support plate 52 is the primary suspension plate of the double suspension shock absorbing system. The vibrator 55 (such as the rotary device) is coupled to the primary suspension plate (i.e. the support plate 52). The connecting plate 54 is located between the upper damper and lower dampers 511 and 513. The cover plate 53 covers the upper damper 511 from an outer side. The cover plate has a cylinder 531 connected to the support plate 52 via the through hole 514 so as to secure the column 51 and the connecting plate 54 to the support plate 52.

Similarly, the neck zone 512 of the column 51 has at least one groove 515. The groove 515 can reduce the contacting area between the neck zone 512 and the connecting plate 54 so as to increase the flexibility of the column 51 in the horizontal direction without reducing the height of the neck zone 512. Therefore, the horizontal natural vibration frequency of the column 51 in the horizontal direction is reduced, and the horizontal natural vibration frequency is proximate the operation frequency of the vibrator 55 to improve the shock absorbing effect in the horizontal direction.

The upper damper 511 has a first recess 516, and the lower damper 512 has a second recess 517. A first apex A is defined in the inmost portion of the first recess 516, a second apex B is defined in the inmost portion of the groove 515, and a third apex C is defined in the inmost portion of the second recess 517. The first apex A and the second apex B are staggered vertically to adjust the vertical natural vibration frequency of the column 51 in the vertical direction. In addition, the third apex C is staggered from the second apex B vertically to adjust the vertical natural vibration frequency of the column 51 in the vertical direction. The stepwise structure of the recesses 516 and 517 is to increase the rigidity of the column 51 in the vertical direction and increase the vertical natural vibration frequency in the vertical direction. In addition, the vertical natural vibration frequency can coincide with the operation frequency of the vibrator 55 to achieve better shock absorbing effect in the vertical direction.

By means of the construction set forth above, when the shock absorber according to the invention is adopted for use on the shock absorbing system of a disc drive, the natural vibration frequencies in various directions may be altered without changing the dimensions and specifications of the damper structure, and the natural vibration frequencies may be adjusted to coincide with the operation frequency of the vibrator to achieve optimal shock absorbing effect in various directions.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A shock absorber for absorbing shock energy generated by a vibrator positioned on a connecting plate, the shock absorber comprising:
a column having an upper damper, a neck zone coupled with the connecting plate, a lower damper and a through hole located in the center of the column;
a support plate located below the lower damper for holding the column;
a cover plate positioned above and covered the upper damper; and
a cylinder connected to the support plate via the through hole so as to secure the column and the vibrator with the support plate;
wherein the neck zone has at least one groove to reduce a contacting area between the neck zone and the connecting plate so as to reduce a horizontal vibration frequency of the column in a horizontal direction.

2. The shock absorber of claim 1, wherein the upper damper has a first recess, a first apex is formed on a first inmost position of the first recess, a second apex is formed on a second inmost position of the groove, and the second apex is staggered vertically from the first apex for adjusting a vertical vibration frequency of the column in a vertical direction.

3. The shock absorber of claim 1, wherein the lower damper has a second recess, a second apex is formed on a second inmost position of the groove, a third apex is formed on a third inmost position of the second recess, and the second apex is staggered vertically from the third apex for adjusting a vertical vibration frequency of the column in a vertical direction.

4. The shock absorber of claim 1, wherein the support plate is a base of a disc drive, and the vibrator is a rotary device of the disc drive.

5. The shock absorber of claim 1, wherein the connecting plate is a primary suspension plate.

6. A shock absorber for absorbing shock energy generated by a vibrator, the shock absorber comprising:
a column having an upper damper, a neck zone, a lower damper and a through hole located in the center of the column;
a support plate located below the lower damper for holding the column;
a cover plate located above and covered the upper damper; and
a cylinder connected to the support plate via the through hole;
wherein the upper damper has a first recess, a first apex is formed on a first inmost position of the first recess, a second is formed on a second inmost position of the neck zone, and the second apex is staggered vertically from the first apex for adjusting a vertical vibration frequency of the column in a vertical direction.

7. The shock absorber of claim 6, wherein the shock absorber is positioned on a connecting plate, the neck zone has at least one groove to reduce a contacting area between the neck zone and the connecting plate so as to reduce a horizontal vibration frequency of the column in a horizontal direction.

8. The shock absorber of claim 7, wherein the second apex is located in the groove.

9. The shock absorber of claim 7, wherein the connecting plate is a primary suspension plate.

10. The shock absorber of claim 6, wherein the lower damper has a second recess with a third apex formed on a third inmost position of the second recess, and the second apex is staggered vertically from the third apex for adjusting the vertical vibration frequency of the column in the vertical direction.

11. The shock absorber of claim 6, wherein the support plate is a base of a disc drive, and the vibrator is a rotary device of the disc drive.

12. A shock absorber for absorbing shock energy generated by a vibrator, the shock absorber comprising:
a column having an upper damper, a neck zone, a lower damper and a through hole located in the center of the column;
a support plate located below the lower damper for holding the column;
a cover plate located above and covered the upper damper; and
a cylinder connected to the support plate via the through hole;
wherein the upper damper has a first recess, the lower damper has a second recess, a first apex is formed on a first position of the first recess, a second apex is formed on a second inmost position of the neck zone, a third apex is formed on a third inmost position of the second recess, and the second apex is staggered vertically from the third apex for adjusting a vertical vibration frequency of the column in a vertical direction.

13. The shock absorber of claim 12, wherein the shock absorber is positioned on a connecting plate, the neck zone has at least one groove to reduce a contacting area between the neck zone and the connecting plate so as to reduce a horizontal vibration frequency of the column in a horizontal direction.

14. The shock absorber of claim 13, wherein the second apex is located in the groove.

15. The shock absorber of claim 13, wherein the connecting plate is a primary suspension plate.

16. The shock absorber of claim 12, wherein the first apex is staggered vertically from the second apex for adjusting the vertical vibration frequency of the column in the vertical direction.

17. The shock absorber of claim 12, wherein the support plate is a base of a disc drive, and the vibrator is a rotary device of the disc drive.
